(19) United States
(12) Patent Application Publication
(10) Pub. No.: US 2026/0276963 A1
(43) Pub. Date: Sep. 17, 2026

(54) CONFOCAL MICROSCOPE AND METHOD FOR CONFOCAL MICROSCOPY, WITH AUTOMATIC FOCUSING

(71) Applicant: Bruker Switzerland AG, Fällanden (CH)

(72) Inventors: Alexander KLENNER, Zurich (CH); David STEINMETZ, Graben-Neudorf (DE); Urs Bernhard ISLER, Zurich (CH)

(21) Appl. No.: 19/166,736

(22) PCT Filed: Mar. 7, 2024
(86) PCT No.: PCT/EP2024/055960

§ 371 Date: Sep. 18, 2025

(30) Foreign Application Priority Data
Mar. 21, 2023 (DE) 102023202529.9

(51) Int. Cl. G02B 21/00; G01N 21/64

(52) U.S. Cl. CPC G02B 21/006; G01N 21/6458; G02B 21/0076; G01N 2021/6478

(57) ABSTRACT

The invention relates to a confocal microscope (1) comprising:
an excitation light source (5) for an excitation light beam (6),
an excitation light beam splitter (7),
a point detector (14) with detector lens (13) for sample light (10) returning from a sample (2),
a microscope objective (4),
a movement device (3) for adjusting a relative distance (AB) between the microscope objective (4) and the sample (2),
an analysis device (16) comprising an analysis beam splitter (8) for coupling out a portion (11a) of the sample light (10) returning from the sample (2), an analysis lens system (12) for focusing the coupled-out portion (11a) toward an analysis detector (17), the analysis detector (17) for detecting the coupled-out portion (11a), and a modulation device (22) with which the refractive power of the analysis lens system (12) and/or a relative distance (RA) between the analysis detector (17) and the analysis lens system (12) can be cyclically varied over time according to a modulation signal (140), wherein, based on a detector signal (150) of the analysis detector (17) a focus time (tₓ) is determined at which the coupled-out portion (11a) is focused on the analysis detector (17) and with which a distance control signal for the movement device (3) is generated. The confocal microscope makes possible a simple and reliable automatic tracking of the distance between the sample and the microscope objective.

The invention relates to a confocal microscope for imaging a sample, in particular the surface of the sample. The invention further relates to a use of such a confocal microscope and a method for imaging a sample by means of confocal microscopy.

In confocal microscopy, an excitation light beam is focused onto a sample, typically the surface of the sample, using a microscope objective to focus it at a point. Sample light emanating from the sample is imaged via the microscope objective and detector lens onto a zero-dimensional detector (also called a point detector). A so-called confocal pinhole (also called detector aperture or entrance aperture of the point detector), which is located in a conjugate plane of the microscope objective, ensures that essentially only sample light from the illuminated point of the sample reaches the point detector. Scattered light is not imaged onto the point detector or blocked by the detector aperture. In order to image an extended region of the sample, different locations of the sample within this region are measured one after the other (scanning the sample).

In confocal microscopy, the excitation light is concentrated in a very small volume of the sample, which allows even comparatively weak interactions with the excitation light, such as fluorescence light generated in the sample or Raman-scattered light, to be measured. On the other hand, compared to a conventional light microscope, there is a significantly higher resolution in the axial direction (direction of beam propagation). This allows on the one hand the measurement of samples in three dimensions, but on the other hand, the examination of uneven, rough or tilted sample surfaces is made significantly more difficult. In the case of opaque samples, the intensity of the measured signal of the sample light also decreases as soon as the focus of the excitation light no longer coincides with the surface of the sample. Finally, even with a flat sample, the axial distance of the sample from the microscope objective can change during scanning, for example due to temperature change (“drift”), which also makes measurement of the surface more difficult. In other words, when the sample is scanned, the sample or its surface risks falling out of the focus of the excitation light.

Various methods have become known in the prior art for tracking the distance between a sample and a microscope objective during scanning of an imaging region of a sample.

In the internet article “Topographic confocal Raman imaging using true surface microscopy,” WITec Instruments Corp., Maryville, Tennessee, USA, dated Sep. 1, 2011, posted at Spectroscopy online (www.sectroscopyonline.com), it is proposed to first take a first scan of the topography of the desired imaging region of the sample using a confocal chromatic sensor, and then in a second scan along the learned surface to create a Raman image using confocal microscopy. This procedure is quite time-consuming due to the two scans that must be performed, and it usually cannot compensate for drift at the confocal microscope.

The company brochure “PureFocus 850 Manual Version 2.4” of Prior Scientific Ltd., Cambridge, UK, dated June 2022, pages 6-8, describes an autofocus functionality for existing microscope systems for installation between the objective lens and the tube lens. It is proposed to direct a beam of an auxiliary laser at a predetermined angle onto the sample surface via an adjustable collimating lens, a dichroic mirror and the objective lens. One half of the laser beam is shaded with a knife-edge aperture. Light from the auxiliary laser reflected from the sample is imaged onto a spatially resolving detector via the objective lens and the collimation lens. Depending on the distance of the sample from the imaging optics, the position of the line on the spatially resolving detector changes, which provides information for automatically controlling the focus position of the microscope and allows the sample to be kept in focus. A disadvantage of this approach is, on the one hand, the structural complexity due to the auxiliary laser, the wavelength of which should not overlap with the wavelength of the light required for the sample examination or generated during the sample examination. On the other hand, if the sample is tilted unfavorably, the reflected laser beam may be deflected so far that it is no longer imaged onto the spatially resolving detector.

DE 10 2017 203 492 A1 (WITec) describes a method and a device for imaging a sample surface with a topography by means of confocal microscopy. The sample is measured using a first laser light source in a Raman or fluorescence measurement. An angular distribution of an incident auxiliary laser beam from a second laser light source is periodically changed by means of an electrically tunable lens, and the laser beam modulated in this way is directed onto the sample via a beam splitter and the microscope objective. Light from the second light source, reflected from the sample, is passed through the microscope objective and the beam splitter to a point detector, and the output is analyzed. This detector signal is used for a re-adjustment to keep the sample in the focal plane for fluorescence or Raman measurement. The first light source and the second light source have non-overlapping wavelength ranges. The disadvantage of this approach is the comparatively complex structure due to the second light source. Furthermore, it is often difficult to prevent the wavelength range of the second laser light source overlapping the wavelength range of the first laser light source or even the excitations generated in the sample. In addition, the working region is limited due to the necessary distance between the electrically tunable lens and the microscope objective.

From U.S. Pat. No. 10,067,058 B1 (Renishaw), which is regarded as the closest prior art, an auto-focus system has become known with which, in particular, Raman spectroscopy measurements can be carried out on a sample to create a spectroscopic image of the sample. Excitation light from an excitation laser source is focused onto the sample via two beam splitters and a microscope objective. Light returning from the sample is guided via the microscope objective and the beam splitter closer to the sample to a first portion via an autofocus lens, a mask with two eccentric apertures and a beam deflection wedge in front of one of the apertures and a refocusing lens to a spatially resolving detector, and a second portion via the further beam splitter to a spectrometer. From the positions of the partial beams generated from the first portion on the spatially resolving detector, a control signal is generated for tracking a sample holder in front of the microscope objective. The disadvantage of this approach is that determination of the positions of the partial beams with the spatially resolving detector is error-prone and slow. Light reflected from the sample must pass through the apertures of the mask with sufficient intensity, which may no longer be the case, in particular if the sample is tilted significantly. In addition, spatially resolved detectors often have only small acceptance ranges for laser power, usually by a factor of 8; in Raman spectroscopy, depending on the sample requirements, excitation laser powers are required that differ by up to a factor of 100, so optical filters must be installed. In addition, the working region is limited due to the necessary distance between the lenses of the autofocus system and the microscope objective.

DE 10 2017 217 320 B4 (Mitutoyo) describes a lens system with variable focal length and focus control. A light source produces an output light that is directed onto a workpiece via a partial mirror and through an objective lens. Resulting workpiece light passes through the objective lens, the partial mirror, a tube lens, and a relay lens, then passes through a beam splitter, a variable focal length lens, another beam splitter, and another relay lens which directs the workpiece light onto a detector. In addition, a control light source is provided which couples a focus detection light into the system via the beam splitter. The focus detection light then also passes through the variable focal length lens and is coupled out at the beam splitter and directed onto a focus control section which includes a focus photodetector.

DE 10 2019 219 506 A1 (Mitutoyo) describes a method for calibrating a lens system with variable focal length by using a calibration object with a flat inclined sample surface. Workpiece light from a workpiece passes through a plurality of lenses, including a variable focal length lens, and is registered at a detector.

### OBJECT OF THE INVENTION

The object of the invention is to present a confocal microscope in which automatic tracking of the distance between the sample and the microscope objective is possible in a simple and reliable manner.

### DESCRIPTION OF THE INVENTION

This object is achieved according to the invention by a confocal microscope for imaging a sample, in particular the surface of the sample, comprising
an excitation light source, in particular an excitation laser, for generating an excitation light beam,
an excitation light beam splitter for coupling-in the excitation light beam,
a point detector for registering sample light caused by the excitation light beam and returning from the sample, in particular from the surface of the sample,
a microscope objective for focusing the excitation light beam onto the sample, in particular onto the surface of the sample, and for collecting the sample light returning from the sample,
a detector lens for imaging the sample light returning from the sample and collected by the microscope objective onto the point detector,
a movement device for adjusting a relative distance between the microscope objective and the sample according to a distance control signal,
an analysis device comprising an analysis beam splitter for coupling-out a portion of the sample light returning from the sample, an analysis lens system for focusing the coupled-out portion of the sample light toward an analysis detector, and the analysis detector for detecting the coupled-out portion of the sample light, wherein the analysis device is configured to generate the distance control signal for the movement device, furthermore
wherein the analysis device comprises a modulation device with which the refractive power of the analysis lens system and/or a relative distance between the analysis detector and the analysis lens system can be cyclically varied in time according to a modulation signal,
wherein the analysis device is designed to determine, in a relevant modulation cycle of the modulation signal, a focus time at which the coupled-out portion of the sample light is focused on the analysis detector on the basis of a detector signal of the analysis detector,
and wherein the analysis device is designed to generate the distance control signal for the movement device by means of the focus time in the relevant modulation cycle.

### Overview

The present invention proposes a confocal microscope in which the excitation light is used not only to measure the sample but also to track the sample (in particular the local sample surface) relative to the microscope objective. To control the relative tracking, the analysis device (also called focus-finder module) is used, which acts on a coupled-out portion of the sample light returning from the sample.

A portion of the sample light returning from the sample is coupled out with an analysis beam splitter, guided to an analysis lens system, modulated by a modulation device, and detected at an analysis detector in order to generate a distance control signal. A remaining portion of the sample light returning from the sample is directed to a point detector in order to obtain information about the sample. This remaining portion of the sample light does not reach the analysis lens system and is not modulated by the modulation device.

The modulation device changes the location of the focus of the coupled-out portion of the sample light relative to the analysis detector. Correspondingly, a cyclically varying counter-compensation is carried out for any momentary defocusing of the excitation light focus relative to the sample (or sample surface). The analysis detector can then be used to determine the momentary correct counter-compensation, and from this the distance control signal for the tracking of the sample relative to the microscope objective can be obtained.

No additional light source is required in addition to the excitation light source, thus keeping the setup simple and right from the start prevents interference with the actual sample measurement due to overlapping wavelength ranges. The coupled-out portion of the sample light can in principle be used completely in its analysis, which increases the reliability of the method. The coupled-out portion has its origin in a sample light that was generated with the complete excitation light beam without partial shadows or preferred angles on the sample. In addition, the coupled-out portion is generally generated from the sample light returning from the sample without any partial shadows or preferred directions and is further processed during its analysis. This significantly improves the tolerance of the method to any sample tilting, in particular also strong sample tilting with respect to certain directions.

The analysis detector does not require a spatial resolution function and is preferably selected accordingly as a zero-dimensional detector. The analysis detector can easily be selected with a wide acceptance range (Pmax/Pmin), for example Pmax/Pmin≥50 or Pmax/Pmin≥100, which is in particular advantageous for Raman measurements.

The analysis of a coupled-out portion of the sample light emanating from the sample also facilitates a compact design by the use of relay lens system.

### Measurement Procedure

During a measurement, the sample is moved (scanned) over a certain region transversely to the propagation direction of the excitation light beam. With the distance control signal, the sample can be tracked in the axial direction (propagation direction of the excitation light beam) relative to the microscope objective and thus the local sample surface can always be kept at a desired distance from the microscope objective, even if the sample surface has considerable roughness.

The analysis device can be used to determine the momentary angular distribution/divergence of the sample light or a portion thereof behind the microscope objective. For example, the angular distribution/divergence of the excitation light reflected from the sample or the sample surface depends on its momentary distance from the microscope objective. If the sample surface is in the focus of the microscope objective, the sample light being examined will be collimated behind the microscope objective; this typically also corresponds to the desired distance setting for imaging/measuring a particular location on the sample.

By means of the analysis device, a portion of the sample light is coupled out behind the microscope objective (“coupled-out portion”) and focused with the analysis lens system toward the analysis detector in order to investigate the angular distribution/divergence of this coupled-out portion of the sample light. The axial position of the focus behind the analysis lens system varies depending on the angular distribution/divergence of the sample light; this variation in location therefore contains the necessary information about the angular distribution/divergence and thus about the defocusing of the confocal microscope. Furthermore, by means of the modulation according to the invention (change in the refractive power of the analysis lens system and/or change in the distance between the analysis detector and the analysis lens system) with the modulation device, the location of the focus of the investigated portion of the sample light behind the analysis lens system relative to the analysis detector is varied in a known manner over a certain range. By reading the analysis detector during a modulation cycle, the (momentary) angular distribution/divergence of the sample light behind the analysis lens system is effectively determined.

The confocal microscope or the analysis device is calibrated so that when the angular distribution/divergence of the sample light (and thus the relative distance between the microscope objective and the sample) is set as desired for the relevant measurement (typically with the sample surface in the focus of the microscope objective), then the distance control signal derived from the focus time in the modulation cycle causes the momentary relative distance between the sample and the microscope objective to be maintained, and otherwise the distance control signal causes the relative distance to be changed toward the desired distance.

In particular, calibration can be used to define a target focus time in the modulation cycle at which the focus time in the modulation cycle should lie, i.e. at which the focus of the coupled-out portion of the sample light should fall on the analysis detector (or its entrance aperture). For example, a calibration sample (typically with a very flat surface) is first brought to the desired relative distance from the microscope objective by using a corresponding distance control signal; for example, the distance control signal can be adjusted so that the sample light signal is maximized at the point detector of the confocal microscope. The focus time in the modulation cycle is then determined in this state; this focus time is then saved as the target focus time and can be used for future samples that are to be examined. It should be noted that, instead of a calibration sample, a sample to be examined can also be used directly to determine the target focus time; this calibration can then also be used for other samples to be examined, if desired. In case of rapidly changing measurement conditions (e.g. temperature fluctuations), such a calibration can also be repeated for each sample to be examined before the start of the measurement.

For the confocal microscope, it is also preferably determined in advance how the focus time in the modulation cycle changes quantitatively when the distance control signal changes (“control function”); this control function can, within the scope of the invention, in many cases (particularly using a relay lens system), be described with sufficient accuracy in a linear function. At least it should be qualitatively determined in which direction the distance control signal must be changed in order to shift the focus time in a certain direction in the modulation cycle (“directional knowledge”). The control function and directional knowledge are essentially system properties of the confocal microscope which generally do not need to be re-determined during calibration.

During subsequent measurement/imaging of samples, the distance control signal can now be adjusted or tracked at each measuring location so that the momentary focus time corresponds to the stored target focus time. This sample (or its local sample surface) will then also be located at the current measuring location at the desired relative distance from the microscope objective. When adjusting/tracking the distance control signal, knowledge of the control function or at least directional knowledge can be used.

It should be noted that the target focus time corresponds to a target focus elongation of the modulation signal, and accordingly these quantities carry equivalent information about the target distance between sample and microscope objective. Likewise, the (momentary) focus time corresponds to a (momentary) focus elongation of the modulation signal, and accordingly these quantities carry equivalent information about the momentary distance between sample and microscope objective. In practice, against this background and in accordance with the invention a variant provides that the (momentary) focus elongation of the modulation signal is determined via the (momentary) focus time in the modulation cycle. For example, in a modulation cycle, the modulation signal (e.g. the control signal/control voltage of an ETL) changes continuously over time between a minimum and a maximum (e.g. sinusoidally). At the time of focus, the modulation signal is read, thus obtaining the focus elongation. The distance control signal can then be determined from the focus elongation, in particular by comparing it to the target focus elongation.

Note that a height profile of the sample surface can be created via the distance control signal as a function of the grid location.

### Beam Splitter Arrangements

Different arrangements can be chosen for the arrangement of the excitation light beam splitter for coupling-in the excitation light beam and the analysis beam splitter for coupling-out the portion of the sample light.

In general, the excitation light beam splitter is placed between the microscope objective and the detector lens.

In a short-distance (KD) arrangement of the two beam splitters, both beam splitters are arranged between the sample and the point detector, typically between the microscope objective and the detector lens. For example, the analysis beam splitter can be arranged between the microscope objective and the excitation light beam splitter, and the excitation light beam splitter can be arranged between the analysis beam splitter and the detector lens. Separate, parallel beam paths are set up for the excitation light beam to be coupled-in and for the coupled-out portion of the sample light. The KD arrangement is characterized by a particularly short optical path length between the microscope objective and the analysis device.

The two beam splitters can also be arranged in long-distance (LD) mode, allowing more sample light to reach the point detector, because the sample light only has to pass through the excitation light beam splitter on its way to the point detector. In the LD arrangement, only the excitation light beam splitter is positioned between the microscope objective and the detector lens, but not the analysis beam splitter. The analysis beam splitter is arranged between the excitation light source and the excitation light beam splitter. The excitation light beam to be coupled-in and the coupled-out portion of the sample light pass along an identical partial beam path between the excitation light beam splitter and the analysis beam splitter.

In a special case of the KD arrangement, the analysis beam splitter and the excitation light beam splitter can also be combined in a wedged beam splitter; a wedge creates a reflection at the front and back, thus creating two separate optical paths. One path then serves to reflect the excitation light toward the microscope objective, the other path serves to couple the sample light into the analysis lens system.

### Aspects of Excitation Light and Sample Light and Other Aspects

The excitation light preferably comes from a monochromatic excitation laser.

The sample light includes excitation light elastically backscattered from the sample (reflection light) and/or fluorescence light generated by the excitation light in the sample and/or excitation light inelastically backscattered from the sample (Raman light). The elastically backscattered excitation light has the same frequency (or frequency spectrum) as the excitation light. Fluorescence light and Raman light are frequency-shifted relative to the excitation light. Depending on the portion of the sample light evaluated by the point detector, the confocal microscope can be used for confocal light microscopy, confocal fluorescence microscopy or confocal Raman microscopy.

The sample light returned from the sample by the excitation laser beam is used to image the sample and is characteristic of the local sample properties. From fluorescence light and/or Raman light, the local chemical composition of the sample can be determined; from reflected light, at least the local reflectivity (i.e. the “brightness” or, in the case of a spectrally resolved measurement, the “color”) of the sample can be determined. The point detector can be designed in particular as a spectrograph with a (confocal) pinhole as the entrance aperture.

The analysis beam splitter and the excitation light beam splitter typically have different reflection properties. An optical filter, for example a bandpass filter, typically serves as an excitation light beam splitter which spectrally separates the sample light for use in the point detector from the elastically backscattered excitation light (in particular for Raman or fluorescence microscopy). Typically, the optical filter blocks the transmission of the excitation light. The analysis beam splitter is typically an intensity beam splitter, for example a glass plate that reflects a small portion of the sample light (approximately spectrally independently).

The analysis device generally utilizes the elastically backscattered excitation light (reflection light) in the sample light; for the method according to the invention, a comparatively small amount of light reflected back into the confocal microscope is sufficient, which particularly improves the tolerance to sample tilting. The portion of reflected light usually dominates the sample light. The analysis beam splitter has a reflectivity of typically 10% or less, preferably 5% or less, for coupling-out the portion of the sample light returning from the sample to the analysis lens system and the analysis detector. The excitation light beam is then only slightly attenuated on the way to the sample and/or the sample light on the way to the point detector, and a correspondingly high intensity of sample light is available for measuring/imaging the sample.

To adjust the relative distance between the microscope objective and the sample, the movement device can move the sample in the propagation direction of the excitation light beam, particularly in the case of a stationary microscope objective, or alternatively, in the case of a stationary sample, move the microscope objective in the propagation direction of the excitation light beam (movement in the z direction). Preferably, the movement device can also be used to move the sample for scanning transversely to the beam propagation direction relative to the microscope objective (movement in x, y directions); alternatively, a further, independent movement device can also be provided for scanning.

### Preferred Embodiments of the Invention

In a preferred embodiment of the confocal microscope, it is provided that the analysis device is designed to indirectly generate the distance control signal for the movement device by means of the focus time in the relevant modulation cycle by an elongation of the modulation signal being read at the focus time, and the distance control signal for the movement device being generated by means of this elongation of the modulation signal at the focus time. The elongation of the modulation signal at the focus time, also called focus elongation, contains particularly precise information about the momentary distance between the sample and the microscope objective, and thus allows particularly precise tracking of the sample.

An embodiment of the confocal microscope according to the invention is preferred in which the analysis lens system comprises an electrically tunable lens whose refractive power can be cyclically varied over time by means of the modulation signal. With the electrically tunable lens, the location of the focus of the coupled-out portion of the sample light can be changed relative to the analysis detector. This is structurally simple and cost-effective, and allows a particularly rapid determination of the momentary focus time (and thus indirectly the focus elongation) in the cycle of the modulation signal. Good mechanical stability of the confocal microscope can also be achieved overall. In this embodiment, both the analysis lens system and the analysis detector are typically stationary. The electrically tunable lens is typically formed by a fluid-filled volume that is bounded on at least one side by a membrane. This membrane can be deformed by a moving coil so that a desired lens curvature and thus refractive power is achieved.

In a preferred development of this embodiment, a modulation frequency of the modulation signal corresponds to a natural frequency of the electrically tunable lens. In this case, particularly large tuning ranges of the refractive power can be achieved.

Furthermore, a further development is particularly preferred which provides that the analysis lens system comprises the electrically tunable lens on the input side and further comprises a non-tunable, imaging optical element, in particular a non-tunable lens, on the output side. The non-tunable, imaging optical element (usually a fixed lens) can be used to shift the adjustment range of the analysis lens system or the distance tracking range of the confocal microscope. Typically, the adjustment range of the analysis lens system is shifted so that it is symmetrical around the desired focal point.

A preferred embodiment is one in which the electrically tunable lens is aligned horizontally. In this case, distortions on the membrane of the electrically tunable lens caused by gravity are minimized, in particular asymmetrical distortions are minimized.

In an alternative embodiment, the analysis detector is arranged on a wobble device with which the position of the analysis detector in the propagation direction of the coupled-out portion of the sample light can be changed cyclically over time, in particular wherein the analysis lens system are designed stationary. The wobble device can also be used to change the location of the focus of the coupled-out portion of the sample light relative to the analysis detector. With the wobble device, the determination of the momentary focus time (and thus the momentary focus elongation) is typically somewhat slower than with an electrically tunable lens; however, the wobble device is usually less sensitive to any high-frequency vibrations than is an electrically tunable lens. In this embodiment, the refractive power of the analysis lens system is typically not tunable.

### Embodiments Relating to Relay Lens System

Particularly preferred is an embodiment which provides for a relay lens system to be arranged between the analysis beam splitter and the analysis lens system and to be used to image the output pupil of the microscope objective onto an entrance pupil of the analysis lens system with an imaging factor ABF. With the relay lens system, a shift of the compensable detuning range and/or an increase of the maximum compensable detuning range of the distance between sample and microscope optics can be achieved. In particular, the relay lens system can be used to prevent the focus of the coupled-out portion of the light from passing through the location of an electrically tunable lens of the analysis lens system over the desired detuning range of the confocal microscope, which would render the directional knowledge (see above) for tracking the distance between the sample and the microscope objective in the desired detuning range no longer clear. It can also be ensured that the focus of the coupled-out portion also reaches the position of the analysis detector (or its entrance aperture) over the desired detuning range, for example in the middle of the desired detuning range. When the exit pupil of the microscope objective is imaged or effectively transferred to the entrance pupil of the analysis lens system using the relay lens system, the angular distribution of the light returning from the sample is changed in accordance with the imaging ratio.

A preferred development of this embodiment provides that the relay lens system comprise an even number N of imaging element groups, each imaging element group comprising at least one imaging optical element, each imaging element group i being assignable a front focal length FFL_i, a back focal length BFL_i and an effective focal length EFL_i, where i: is the index of the imaging element groups,
and that the exit pupil of the microscope objective is positioned at least approximately at a distance FFL_1 in front of the first imaging element group i=1, and the entrance pupil of the analysis lens system is positioned at least approximately at a distance BFL_N behind the last imaging element group i=N, and adjacent element groups i, i+1 are at least approximately at a distance d (i,i+1)=BFL_i+FFL_i+1 from one another. This makes it a simple matter to set up the relay lens system. In many applications, exactly two mapping element groups are set up, i.e. N=2. The imaging factor ABF can be determined via the ratio of the effective focal lengths. In the case of two imaging groups (with indices 1 and 2), the imaging factor can be determined via the effective focal lengths as ABF=EFL_2/EFL_1. The imaging optical elements may be refractive and/or diffractive and/or reflective and/or comprise meta-optics. The imaging optical elements may comprise lenses, in particular convex lenses and/or concave lenses, and/or curved mirrors, in particular concave mirrors. It should be noted that small variations in the positions of the exit pupil or entrance pupil or in the distances (of the order of magnitude of e.g. up to 2 mm, which corresponds approximately to the axial expansion range when tuning an electrically tunable lens) are not critical for the relay lens system.

A development of this further embodiment is preferred in which at least one imaging element group comprises at least two imaging optical elements. This creates accessibility to more complex beam paths and, if necessary, stronger light refraction in the imaging element group.

Particularly preferred is a development in which the first imaging element group comprises at least two imaging optical elements, and these imaging optical elements are selected such that FFL_1>BFL_1. This makes it possible to achieve a particularly compact design of the relay lens system in the beam propagation direction. For this purpose, the first imaging element group can, for example, contain a convex lens followed by a concave lens/diffuser lens, which together firstly establish a first front focal length FFL_1 that is sufficiently long for the measurement setup and secondly shorten the first back focal length BFL_1.

In an advantageous development of the above embodiment, the imaging factor ABF=1. This is particularly easy to set up; in particular, this “direct” transfer can be set up with a total of only two lenses (so-called 4f correlator), i.e. with two identical imaging element groups, each with only one imaging optical element.

In an alternative, likewise preferred development, it is provided that the imaging factor ABF is magnifying, with ABF>1, in particular where 1<ABF≤3. In many cases, the magnified image can reduce the necessary adjustment range of the refractive power of downstream analysis lens system (or the travel range of the analysis detector) in order to cover a given detuning range of the sample/sample surface. The downstream analysis lens system must have an entrance pupil large enough for the imaging factor.

### Further Embodiments, Uses and Methods

Furthermore, an embodiment of the confocal microscope is preferred which provides that the analysis detector has an entrance aperture with a diameter which is not larger than the diameter of the portion of the sample light which is completely focused by means of the analysis lens system, and that the analysis device is configured to determine the focus time by the intensity of the detector signal in the modulation cycle being at a maximum at the focus time. The sufficiently small entrance aperture ensures a well-detectable, sharp maximum of the intensity of the detector signal when the focus of the coupled-out portion of the sample light falls exactly on the location of the entrance aperture of the analysis detector, and the focus time can be determined with high accuracy, <10 microseconds, preferably <1 microsecond. The sample can then be measured with corresponding precision. The diameter of the focus (perpendicular to the beam propagation direction) is then determined using the 86% criterion, i.e. 86% of the beam power of the coupled-out portion of the sample light lies within a circle of the said diameter.

The scope of the present invention also includes the use of a confocal microscope according to the invention, as described above, for imaging a sample, in particular a surface of the sample, by means of confocal microscopy, in particular confocal light microscopy, confocal Raman microscopy or confocal fluorescence microscopy,
wherein the sample is measured successively at a plurality of measuring locations, wherein for a change of measuring location the sample is moved transversely to the propagation direction of the excitation light beam, and wherein the distance control signal generated by the analysis device is used to keep the relative distance between the microscope objective and a local surface of the sample at the relevant measuring location at least approximately constant across the various measuring locations with the movement device. This allows a uniformly good focusing of the confocal microscope on the sample to be achieved in a simple and reliable manner in the intended imaging region of the sample, which sample is scanned by the measuring locations.

Also within the scope of the present invention is a method for imaging a sample, in particular the surface of the sample, using confocal microscopy, in particular with confocal light microscopy, confocal Raman microscopy or confocal fluorescence microscopy, and in particular wherein the method is carried out on a confocal microscope according to the invention, as described above, comprising the following steps:
an excitation light beam is generated using an excitation light source, in particular an excitation laser,
the excitation light beam is coupled-in by means of an excitation light beam splitter;
a point detector registers the sample light coming back from the sample, particularly from the surface of the sample, caused by the excitation laser beam,
with a microscope objective, the excitation light beam is focused onto the sample, particularly onto the surface of the sample, and the sample light returning from the sample is collected,
by means of a detector lens, the collected sample light coming back from the sample is imaged onto the point detector;
a movement device is used to set a relative distance between the microscope objective and the sample according to a distance control signal,
the distance control signal for the movement device is generated by an analysis device comprising an analysis beam splitter, which couples-out a portion of the sample light returning from the sample, an analysis lens system, which focus the coupled-out portion of the sample light toward an analysis detector, and the analysis detector, which detects the coupled-out portion of the sample light, furthermore
wherein the analysis device comprises a modulation device with which the refractive power of the analysis lens system and/or a relative distance between the analysis detector and the analysis lens system is changed cyclically in time according to a modulation signal,
wherein the analysis device determines, in a relevant modulation cycle of the modulation signal, a focus time at which the coupled-out portion of the sample light is focused on the analysis detector, on the basis of a detector signal of the analysis detector,
and wherein the analysis device generates the distance control signal for the movement device by means of the focus time in the relevant modulation cycle. With the method according to the invention, a sample can be measured easily and reliably using confocal microscopy.

In a preferred variant of the method according to the invention, it is provided that
the point detector is designed as a spectrograph and a spectral composition of the light returning from the sample is analyzed with the spectrograph,
and that fluorescence properties and/or Raman scattering properties of the sample are determined in the sample light returning from the sample,
in particular, in front of the point detector, sample light reflected from the sample, which has the same wavelength as the excitation light beam, is blocked by a filter (possibly with a plurality of filter stages). Within the scope of the invention, fluorescence and Raman microscopy with a good signal-to-noise ratio are possible, in particular when different intensities of the excitation light have to be used to determine different spectral lines. For example, in the case of a Raman microscope, the excitation beam splitter can be selected so that it already provides an initial spectral separation of the excitation light from the Raman-scattered light.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### DETAILED DESCRIPTION OF THE INVENTION AND DRAWINGS

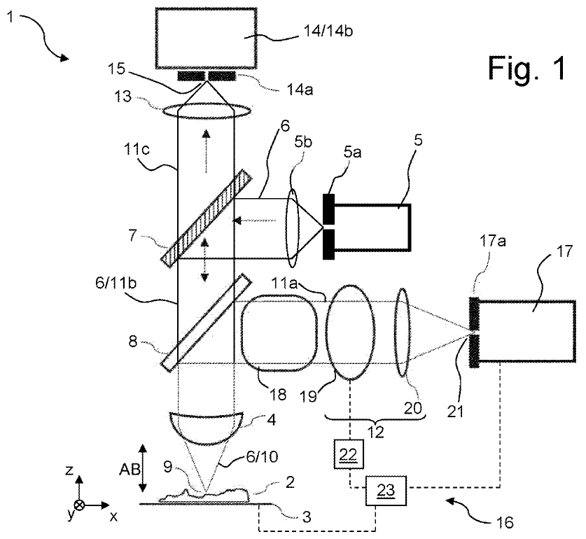

FIG. 1 shows a schematic representation of a first embodiment of a confocal microscope according to the invention, with beam splitters in KD configuration;

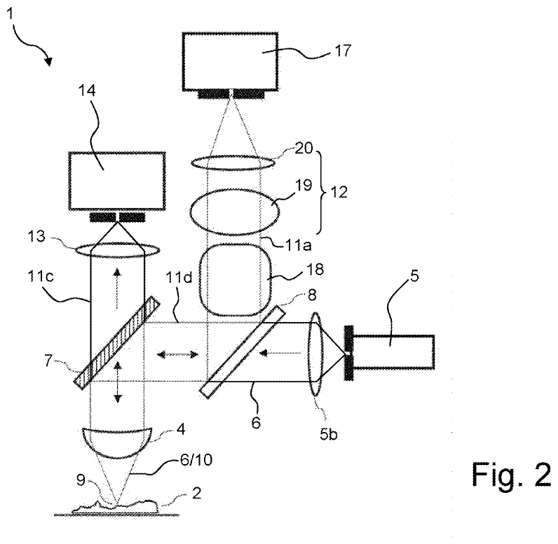

FIG. 2 shows a schematic representation of a second embodiment of a confocal microscope according to the invention with beam splitters in LD configuration;

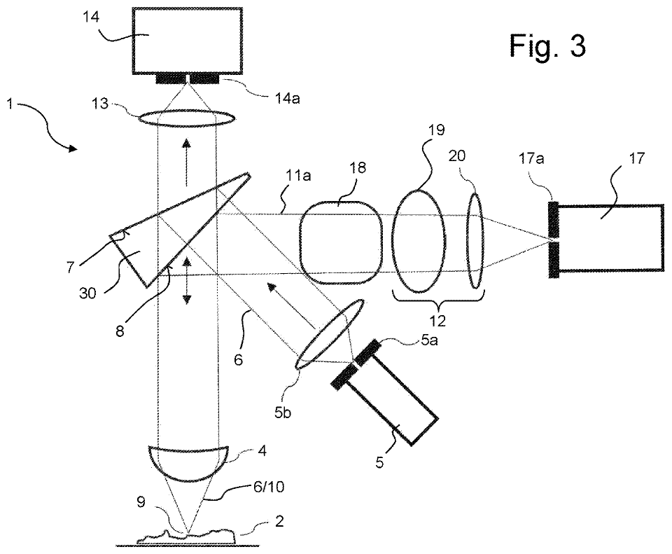

FIG. 3 shows a schematic representation of a third embodiment of a confocal microscope according to the invention with a wedge-shaped beam splitter (and KD configuration);

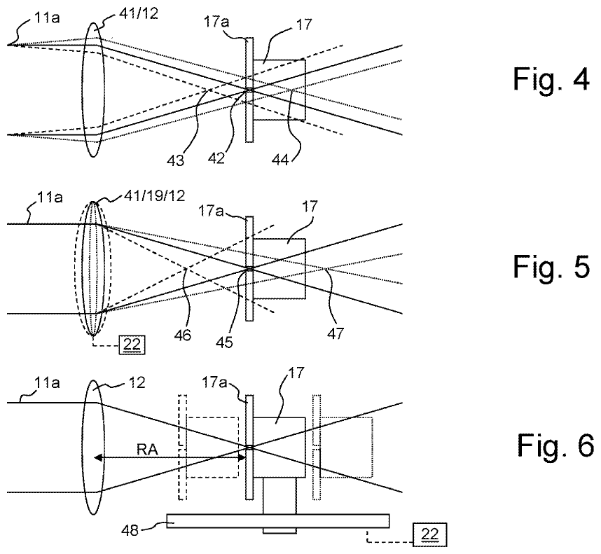

FIG. 4 shows schematically a beam path of the sample light in confocal microscopy in front of a detector (point detector or analysis detector) at different distances from the sample and the microscope objective for the invention;

FIG. 5 shows schematically a beam path of the sample light in front of the analysis detector with different refractive power of an electrically tunable lens for the invention;

FIG. 6 shows schematically a beam path of the sample light in front of the analysis detector, which is arranged on a wobble device, for the invention;

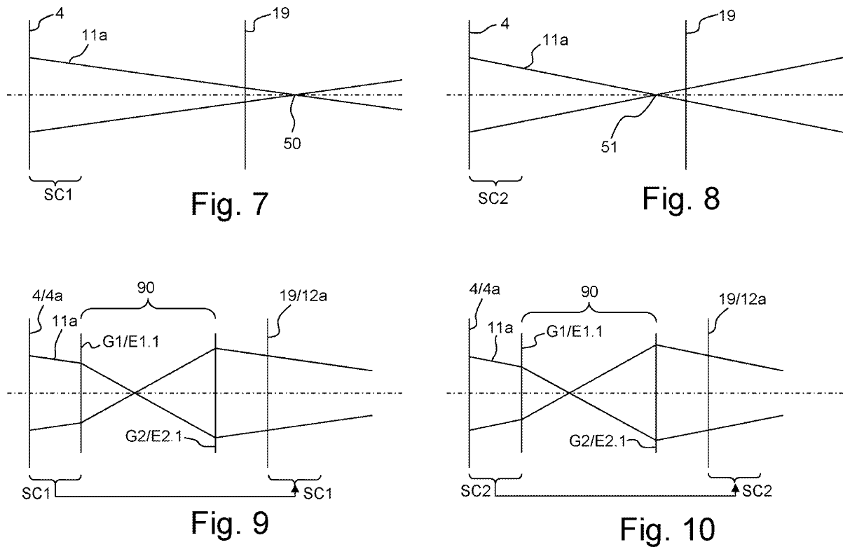

FIG. 7 shows schematically a beam path of the sample light in an analysis device without a relay lens system for a first distance between sample and microscope objective for the invention;

FIG. 8 shows schematically a beam path of the sample light in an analysis device without a relay lens system for a second distance between sample and microscope objective for the invention;

FIG. 9 shows schematically the beam path of the sample light similar to FIG. 7 in an analysis device with a relay lens system for the first distance between sample and microscope objective for the invention;

FIG. 10 shows schematically the beam path of the sample light similar to FIG. 8 in an analysis device with a relay lens system for the second distance between sample and microscope objective for the invention;

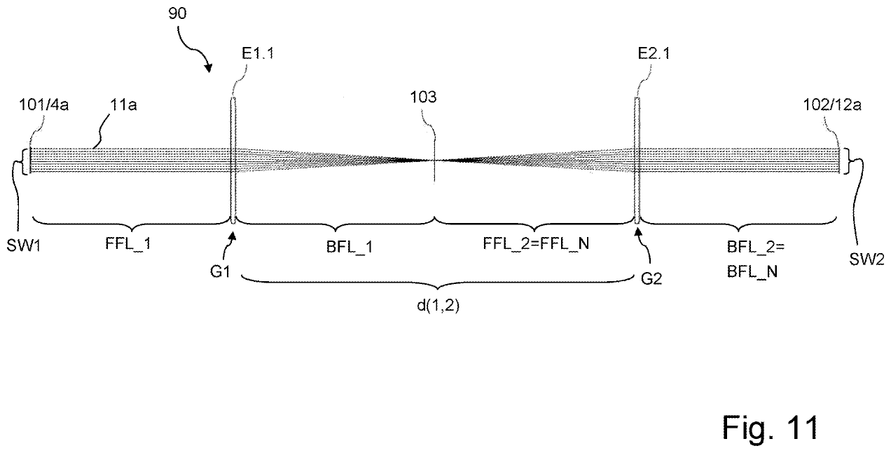

FIG. 11 shows schematically a beam path of the sample light in the region of a relay lens system for the invention, which are constructed as a 4f correlator;

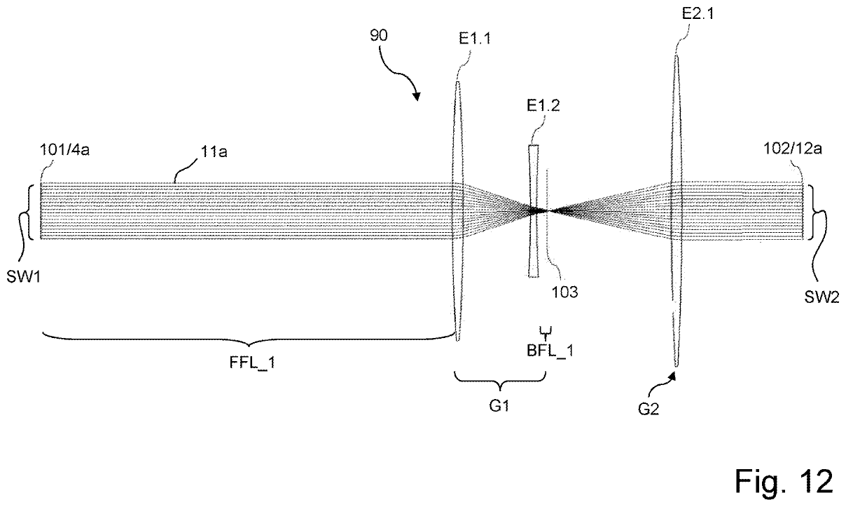

FIG. 12 shows schematically a beam path of the sample light in the region of a relay lens system for the invention, which provides imaging where ABF=1, and wherein a first element group comprises two imaging optical elements;

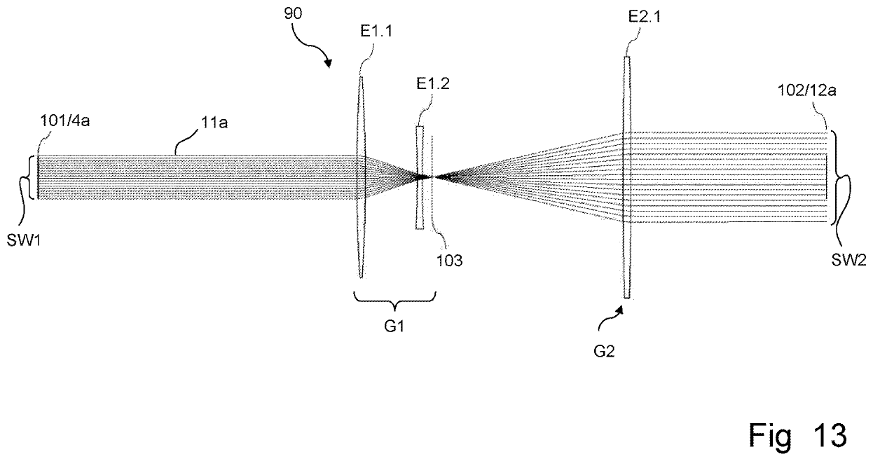

FIG. 13 shows schematically a beam path of the sample light in the region of a relay lens system for the invention, which provides imaging where ABF=2, and wherein a first element group comprises two imaging optical elements;

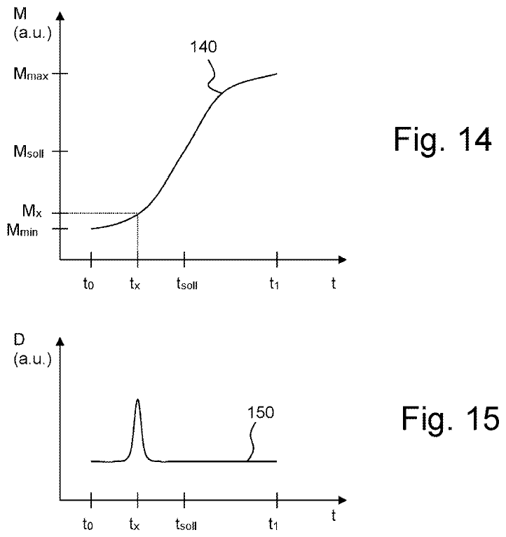

FIG. 14 shows a schematic diagram of a modulation signal over half a modulation cycle with value M of the modulation signal plotted as a function of time t for the invention;

FIG. 15 shows a schematic diagram of a detector signal with signal strength D of the detector signal at an analysis detector as a function of time when the sample has been detuned for the invention.

FIG. 1 shows a schematic representation of a first embodiment of a confocal microscope 1 according to the invention for imaging a sample 2. The sample 2 is arranged on a sample holder 3, which can be moved in three orthogonal spatial directions x, y, z; the movable sample holder 3 is also referred to as the movement device 3 of the sample 2. The sample 2 has a roughness in the direction toward the confocal microscope 1 or its microscope objective 4, i.e. in the z-direction. In order to image the sample 2, different locations on the sample 2 are measured one after the other (“measurement locations”), for which reason the sample holder 3 is moved (scanned) in x and y. In this case, a (local) distance AB between the sample 2 or its local surface and the microscope objective 4 is kept constant over all measuring locations, for which reason the sample holder 3 is tracked in z according to a distance control signal. The sample holder 3 is controlled by an electronic control device 23.

An excitation light source 5, in this case a monochromatic excitation laser with an exit aperture 5a, generates an excitation light beam 6, which is collimated here by means of a lens 5b and which is coupled into the confocal microscope 1 via an excitation light beam splitter 7. In the embodiment shown the excitation light beam 6 is reflected downward by the excitation light beam splitter 7 at its lower boundary surface, passes through an analysis beam splitter 8 and is focused by the microscope objective 4 onto the (local) surface of the sample 2; cf. the sample-side beam focus 9.

The excitation light beam 6 is in part elastically scattered (producing reflected light), in part inelastically scattered (producing Raman light) at the sample 2 in the region of the sample-side beam focus 9, with proportions depending on the sample material, and in part fluorescence is excited in the sample 2 (producing fluorescent light). In summary, sample light 10 is generated at the sample 2 and returns to confocal microscope 1.

The sample light 10 returning from the sample 2 is collimated at the microscope objective 4 (assuming correct focusing). A portion of the sample light 10 is coupled out at the analysis beam splitter 8 (cf. the coupled-out portion 11a) and fed to the analysis lens system 12. The position of the analysis beam splitter 8 shown in FIG. 1 makes possible a particularly short optical path from the microscope objective 4 to the analysis lens system 12 and is therefore termed a short-distance configuration (KD configuration). A non-coupled-out portion 11b of the sample light 10 reaches the excitation light beam splitter 7. This is designed here as an optical filter that blocks the wavelength (or wavelength range) of the excitation light beam 6. For illustration purposes, the representation of the light rays, particularly at the two beam splitters, is simplified and shown without the effects of optical refraction (this also applies to the other figures). A remaining portion 11c of the sample light 10, which is dominated by fluorescence and/or Raman light of the sample 2, passes through the excitation light beam splitter 7 and reaches a detector lens 13, and is focused by the detector lens 13 onto an entrance aperture 14a of a point detector 14. The point detector 14 is designed here to be wavelength-sensitive, i.e. as a spectrograph 14b.

At the point detector 14, only then is a high intensity of the sample light 10 originating from the sample surface of the sample 2 obtained, or only then is the point-detector-side beam focus 15 of the remaining portion 11c of the sample light 10 located in the axial direction (z-direction) at the location of the entrance aperture 14a of the point detector 14, if the sample-side beam focus 9 is also located precisely on the surface of the sample 2 (“confocal” geometry). In this case (as shown in FIG. 1), the sample light 10 is also collimated between the microscope objective 4 and the detector lens 13. If, for example, the sample-side beam focus 9 is located above the local sample surface in the z-direction due to the roughness of the sample 2 (i.e. the sample has a local “valley” or is momentarily “too far away” from the microscope objective 4), a converging beam of the sample light (11b) is obtained, and if the sample-side beam focus 9 is located below the local sample surface in z (i.e. the sample 2 has a local “hill” or is momentarily “too close” to the microscope objective 4), a divergent beam of the sample light (11b) is obtained, in each case as viewed from the microscope objective 4 in the direction of the analysis beam splitter 8.

In order to always keep the momentary distance AB of the sample 2 or the local sample surface from the microscope objective 4 at the desired distance (also called target distance ABsoll, not shown separately), according to the invention an analysis device 16 is employed to use the coupled-out portion 11a of the sample light to carry out an analysis which results in the generation of the distance control signal with which the distance AB of the sample 2 from the microscope objective 4 can always be kept at the desired local distance ABsoll.

The analysis device 16 comprises the analysis beam splitter 8, the analysis lens system 12, an analysis detector 17, a modulation device 22 and the electronic control device 23, as well as a relay lens system 18 between the analysis beam splitter 8 and the analysis lens system 12. The analysis lens system 12 in this case comprise an electrically tunable lens 19 (ETL) and a non-tunable lens 20. The analysis detector 17 is designed, for example, as a photodetector, in particular a zero-dimensional photodetector.

The analysis beam splitter 8 reflects approximately 5% of the total intensity of the sample light 10 as the coupled-out portion 11a toward the analysis lens system 12, approximately independently of the wavelength; the coupled-out portion 11a is accordingly dominated by reflected light. The coupled-out portion 11a of the sample light 10 is focused by the analysis lens system 12 toward the analysis detector 17; cf. the analysis-detector-side beam focus 21. The position of the beam focus 21 depends on the momentary distance AB of the sample 2 or local sample surface from the microscope objective 4.

With the modulation device 22, the position of this beam focus 21 in the axial direction (beam propagation direction of the coupled-out portion 11a, in this case x-direction) relative to the analysis detector 17 or the entrance aperture 17a thereof is cyclically changed (“modulated”) over time, in this case by changing the refractive power of the electrically tunable lens 19. For this purpose, the modulation device 22 generates a modulation signal which in this case controls the lens curvature of the ETL 19 as an electrical voltage on a moving coil (not shown in detail).

Through a modulation cycle, the analysis-detector-side beam focus 21 briefly reaches the axial position of the entrance aperture 17a of the analysis detector 17, whereby its detector signal is maximized. From the time at which this maximum value of the detector signal is reached in the modulation cycle or from the associated elongation (also called focus elongation) of the modulation signal in comparison to a calibrated, desired target time or a calibrated target elongation (also called target focus elongation) in the modulation cycle, the electronic control device 23 can determine the momentary detuning of the distance AB of the sample compared to the desired distance ABsoll, and a suitable distance control signal can be generated to track the sample 2 over the desired distance ABsoll (cf. also FIG. 14 and FIG. 15).

FIG. 2 shows a second embodiment of a confocal microscope 1 according to the invention that is similar to the confocal microscope of the first embodiment in FIG. 1. For this reason, only the essential differences are explained, and for the sake of simplicity, some elements that stay the same are not shown again.

In the confocal microscope 1 in FIG. 2, only the excitation light beam splitter 7, and not the analysis beam splitter 8, is arranged in the beam path between the microscope objective 4 and the detector lens 13. Rather, the analysis beam splitter 8 is arranged between the excitation light source 5 and the excitation light beam splitter 7. The excitation light beam 6 passes through the analysis beam splitter 8 and is reflected at the excitation light beam splitter 7 at its lower boundary surface toward the microscope objective 4. Sample light 10 emanating from the sample 2 is reflected with a first portion 11d toward the analysis beam splitter 8, and a remaining portion 11c passes through the excitation light beam splitter 7, which in turn acts as an optical filter and blocks the wavelength of the excitation light. From the first portion 11d, a coupled-out portion 11a is reflected by the analysis beam splitter 8 toward the analysis lens system 12.

With this design, a particularly high proportion of the sample light 10 can reach the point detector 14. Due to the comparatively long optical path from the microscope objective 4 to the analysis lens system 12, this design is termed a long-distance configuration (LD configuration).

FIG. 3 shows a third embodiment of a confocal microscope 1 according to the invention, similar to the confocal microscope of the first embodiment in FIG. 1. For this reason, only the essential differences are explained, and for the sake of simplicity, some elements that stay the same are not shown again.

In the embodiment in FIG. 3, the excitation light beam splitter 7 and the analysis beam splitter 8 are combined in a common component, namely in a beam deflection wedge 30 (also called wedged beam splitter). An upper boundary surface of the beam deflection wedge 30 acts as the excitation light beam splitter 7, which in particular couples the excitation light beam 6 from the excitation light source 5 and reflects it toward the microscope objective 4. This upper boundary surface of the beam deflection wedge 30 can be designed as an optical filter that blocks the wavelength (or wavelength range) of the excitation light beam 6 by this wavelength being reflected almost completely. A lower boundary surface of the beam deflection wedge 30 acts as an analysis beam splitter 8 and, in particular, couples out a coupled-out portion 11a of the sample light 10 emanating from the sample 2 and reflects this coupled-out portion 11a toward the analysis lens system 12. The material of the beam deflection wedge 30 is typically transparent to the wavelengths of the excitation light beam 6 and of the sample light 10.

With this design, a particularly compact construction can be achieved, and this design also corresponds to a KD configuration.

FIGS. 4 to 6 schematically illustrate various influences on the position of a beam focus in a confocal microscope according to the invention.

FIG. 4 shows schematically and by way of example the beam path of the coupled-out portion 11a of the sample light near a last lens 41 of an analysis lens system 12 in front of an analysis detector 17. Note that analogous conditions apply to the last lens of a detector lens in front of a point detector for the measurement of the remaining portion of the sample light.

When the distance between the sample and the microscope objective is focused, the coupled-out portion 11a is collimated in front of the lens 41 and its focus 42 is imaged exactly onto the axial location of an entrance aperture 17a of the analysis detector 17 (solid lines). In this situation, a detector signal of the analysis detector 17 is at a maximum.

However, if the sample is “too far away” from the microscope objective, the coupled-out portion 11a will be convergent in front of the lens 41 and its focus 43 be located axially in front of the entrance aperture 17a (dashed lines). In this situation, a detector signal of the analysis detector 17 is reduced.

If, on the other hand, the sample is “too close” to the microscope objective, the coupled-out beam 11a will be divergent in front of the lens 41 and its focus 44 be located axially behind the entrance aperture 17a (dotted lines). Also in this situation, a detector signal of the analysis detector 17 is reduced.

According to the invention, the focus position of the coupled-out portion 11a is tuned by means of a modulation device 22, which an electrically tunable lens 19 can tune in its refractive power in FIG. 5. The electrically tunable lens 19 is in this case the last lens of the analysis lens system 12; however, it should be noted that the same would also apply if the electrically tunable lens 19 were, for example, the penultimate lens of the analysis lens system 12 (as shown in FIG. 1). For the sake of simplicity, it is assumed in FIG. 5 that the coupled-out portion 11a is collimated; however, the explained shift of the focus 45 also applies accordingly to a divergent or convergent coupled-out portion 11a.

At a mean refractive power of the ETL 19 (solid lines), in the situation shown in FIG. 5 the focus 45 of the coupled-out portion 11a lies on the axial position of the entrance aperture 17a of the analysis detector 17. In this situation, a detector signal of the analysis detector 17 is again at a maximum.

With increased refractive power of the ETL (dashed lines), the focus 45 is shifted forward, and accordingly the focus 46 is now in front of the entrance aperture 17a.

When the refractive power of the ETL is reduced (dotted line), the focus 45 is shifted backward, and accordingly the focus 47 of the coupled-out portion 11a is then behind the entrance aperture 17a.

If there is now a detuning of the distance of the sample from the microscope objective as compared to the focus (see FIG. 4), and then the refractive power of the ETL 19 is varied cyclically in time with the modulation signal of the modulation device 22 as shown in FIG. 5, the focus 45/46/47 of the coupled-out portion 11a of the sample light will briefly come to the axial position of the entrance aperture 17a. This is precisely the case when the tuning of the refractive power of the ETL 19 from the mean refractive power exactly compensates for the detuning of the distance of the sample from the microscope objective with respect to the focusing. This point in time in the modulation cycle or the corresponding elongation of the modulation signal in the modulation cycle can be determined from the maximum of the intensity of the detector signal in the modulation cycle, and from this a distance control signal can be obtained with which the momentary detuning of the distance of the sample can be eliminated.

It should be noted that the shift of focus due to changing refractive power and the detuning of the sample are monotonically related, so that a monotonic control function can be obtained.

Preferably, by means of the modulation device 22, the focus 45/46/47 of the coupled-out portion 11a can be tuned symmetrically around the central position of the focus 45 belonging to the focusing position.

Instead of adjusting the refractive power of an ETL, according to the invention the position of the analysis detector 17 or the position of its entrance aperture 17a can also be tuned relative to the analysis lens system 12. In other words, the relative distance RA between analysis lens system 12 and analysis detector 17 can be changed. This is illustrated in a schematic and exemplary manner in FIG. 6. The analysis detector 17 is arranged here on a wobble device 48, with which the analysis detector 17 can be moved cyclically in time between a front position (shown in dashed lines) and a rear position (shown in dotted lines), according to a modulation signal of the modulation device 22.

Preferably, by means of the modulation device 22, the (relative) position of the analysis detector 17 can be tuned symmetrically around the central position of the analysis detector 17 (shown in solid line) belonging to the focus.

FIGS. 7 to 10 illustrate the benefits of a relay lens system that can be used within the scope of the invention. The figures each illustrate the beam path of the coupled-out portion 11a of the sample light in the region from the microscope objective 4 to a little behind an electrically tunable lens 19 of an analysis device according to the invention (cf. FIG. 1 in this regard); beam deflections by beam splitters and the beam splitters themselves are omitted for the sake of simplicity.

In a simple design of the analysis device, which is shown in FIG. 7, it is configured without a relay lens system. When focused, the coupled-out portion 11a of the sample light would be collimated behind the microscope objective 4 (not shown). When the distance between the sample and the microscope objective 4 is increased, the coupled-out portion 11a becomes convergent, whereby with slight defocusing the focus 50 remains behind the electrically tunable lens 19. As long as this is the case, the distance tracking between the sample and the microscope objective 4 (i.e. the control of the sample holder in the z-direction) can still be carried out in a clear manner. For samples with little roughness, the invention can be implemented in a simple manner even without a relay lens system.

If the distance between the sample and the microscope objective 4 becomes considerably too large, the focus 51 will move without further action to in front of the electrically tunable lens 19, as shown in FIG. 8, and distance tracking will no longer be possible in a clear manner. It should be noted that for structural reasons, the ETL 19 cannot be positioned as close as desired to the microscope objective 4 (its minimum distance is usually approximately 25 cm for structural reasons); for example, the analysis beam splitter must be placed between them.

Within the scope of the invention, a relay lens system 90 can then be used which is placed between the analysis beam splitter and the analysis lens system. This images an exit pupil 4a of the microscope objective 4 onto an entrance pupil 12a of the analysis lens system. Accordingly, the beam path of the coupled-out portion 11a of the sample light is also imaged, i.e. transferred from the exit pupil 4a to the entrance pupil 12a (if necessary using an imaging factor of the relay lens system 90).

The section SC1 of the beam path of the coupled-out portion 11a in FIG. 7 is identical at the exit pupil 4a in FIG. 9. With the relay lens system 90, this section SC1 is reproduced behind the electrically tunable lens 19, which here represents the entrance pupil 12a of the analysis lens system, and the beam path then continues accordingly (cf. FIG. 7).

Likewise, the section SC2 of the beam path of the coupled-out portion 11a in FIG. 8 is identical at the exit pupil 4a in FIG. 10. With the relay lens system 90, this section SC2 is also reproduced behind the electrically tunable lens 19, which also represents the entrance pupil 12a of the analysis lens system, and the beam path then continues accordingly (cf. FIG. 8).

This ensures that the focus 50, 51 (FIG. 7, FIG. 8) of the coupled-out portion 11a of the sample light in FIG. 9 and FIG. 10, i.e. when using the relay lens system 90, is always behind the electrically tunable lens 19, and the distance tracking is always possible in a clear manner. The entrance pupil 12a of the analysis lens system or the ETL 19 is then located more or less at the location of the microscope objective 4, which increases the detectable detuning range.

In the cases shown in FIG. 9 and FIG. 10, the relay lens system 90 has only two imaging optical elements E1.1, E2.1, each representing an imaging element group G1, G2 (each with only one imaging optical element). In addition, the relay lens system 90 here has an ABF of 1 (more on this below).

FIGS. 11, 12 and 13 illustrate various designs of a relay lens system 90 that can be used for the invention.

FIG. 11 illustrates a first design of relay lens system 90 that can be used within the scope of the invention, and also explains the most important geometric constraints for a relay lens system 90.

The relay lens system 90 here comprise a number of N=2 imaging element groups G1, G2 (the index of the element groups is also denoted by i, in this case i=1, 2); note that a larger, even number N of element groups can also be provided. Each element group Gi comprises one or more imaging optical elements Ei.j, where j is the index of the elements in group i. In the illustrated design, the element group G1 has only the element E1.1, and the element group G2 has only the element E2.1.

The entrance plane 101 of the relay lens system 90 is located at a distance corresponding to the front focal length FFL_1 of the first group G1; the exit pupil 4a of the microscope objective is placed there. The output plane 102 of the relay lens system 90 is located at a distance corresponding to the back focal length BFL_N of the last group GN; the entrance pupil 12a of the analysis lens system is placed here. Note that in the embodiment shown, GN=G2. Consecutive element groups are placed at a distance equal to the sum of the back focal length BFL_i of the front element group i and of the front focal length FFL_i+1 of the back element group i+1. In this case, the element groups G1, G2 are arranged with a distance d (1,2)=BFL_1+FFL_2. Here, centrally between the element groups G1, G2, there is a Fourier plane 103 with an intermediate focus of the coupled-out portion 11a.

In the first configuration in FIG. 11, the elements E1.1 and E2.1 have the same focal length, and all four distances (from 101 to E1.1, from E1.1 to 103, from 103 to E2.1, and from E2.1 to 102) are equal. This corresponds to a so-called 4f correlator. The relay lens system 90 has an imaging factor ABF of 1, so that the beam width SW1 of the coupled-out portion 11a at the input plane 101 is equal to the beam width SW2 at the output plane 102.

FIG. 12 shows another design of relay lens system 90 for the invention, which design largely corresponds to the relay lens system in FIG. 11, so that only the essential differences are explained.

In this design, the first element group G1 has two imaging optical elements E1.1 and E1.2. The first element E1.1 is a convex lens and the second element E1.2 is a concave lens. A suitable choice of lenses and of the distance between E1.1 and E1.2 ensures a large front focal length FFL_1 and a short back focal length BFL_1 of the first element group G1. Accordingly, FFL_1>BFL_1 applies, with FFL_1>3*BFL_1 being preferred or FFL_1>10*BFL_1 being particularly preferred. As a result, a large distance (along the beam propagation direction) from the microscope objective or its exit pupil 4a to the relay lens system 90 can be provided, but at the same time the overall axial length of the relay lens system 90 can be kept small. The analysis lens system and the analysis detector can thus be positioned practically freely, in particular in KD as well as LD configuration (see FIG. 1, FIG. 2 and FIG. 3) and in particular without affecting the working range of the detectable detuning of the confocal microscope.

The relay lens system 90 in FIG. 12 also has an imaging factor ABF of 1, so that the beam width SW1 at the input plane 101 is equal to the beam width SW2 at the output plane 102.

FIG. 13 shows another design of a relay lens system 90 for the invention, which largely corresponds to the relay lens system in FIG. 12, so that only the essential differences are explained.

In this design, the element groups G1, G2 are designed in such a way, and in particular the effective focal lengths EFL_1, EFL_2 of the two groups G1, G2 are selected in such a way, that the relay lens system 90 as a whole has an imaging factor ABF=2, so that the beam width SW2 at the output plane 102 is twice as large as the beam width SW1 at the input plane 101, i.e. SW2=2*SW1.

The beam divergence can be balanced against the beam size via the imaging factor ABF, in particular with ABF>1. In particular, the necessary refractive power of a downstream ETL can be reduced by a magnification (ABF>1).

FIGS. 14 and 15 illustrate schematically and by way of example the determination of a distance control signal for the invention.

In FIG. 14 an exemplary modulation signal 140 which is applied in a modulation cycle between the times t₀ and t₁, in this case as the voltage of an electrically tunable lens, is shown in a diagram. For simplification, only one half of a modulation cycle is shown (in the second half, the modulation signal falls again mirror-symmetrically with respect to t₁; not shown in detail). The value M of the modulation signal 140 (plotted at the top) changes as a function of time t (plotted to the right) between a minimum Mₘᵢₙ and a maximum Mₘₐₓ. According to the calibration carried out, when the value Mₛₒₗₗ of the modulation signal 140 is present, which is reached at time tₛₒₗₗ, the focus of the coupled-out portion of the sample light should be at the location of the input aperture of the analysis detector, and accordingly a detector signal 150 of the analysis detector should be at a maximum. Mₛₒₗₗ is also called target focus elongation, and tₛₒₗₗ is also called target focus time.

At a location on the sample sought during the scanning process, the sample with its local surface should now be moved to the desired distance from the microscope objective (according to the calibration). For this purpose, the detector signal is measured at the analysis detector over a modulation cycle (or a plurality of modulation cycles over which an average is taken), the distance control signal having a current value ABS_{bisher}. The distance control signal may, for example, be a control voltage to be applied to a linear gantry of the z-direction of the sample movement device. Typically, there is initially a detuning, i.e. the sample is not at the desired distance from the microscope objective. An exemplary detector signal 150 measured during detuning and having the detector signal strength D (plotted at the top) at the analysis detector is shown in FIG. 15 as a function of time t (plotted to the right) in the modulation cycle between t₀ and t₁. In fact, due to the existence of a detuning, the maximum of the detector signal 150 occurs at time tₓ (instead of tₛₒₗₗ) in the modulation cycle. This time tₓ is also called the (momentary) focus time and corresponds to a value Mₓ of the modulation signal 140 as shown in FIG. 14. Mₓ is also called the (momentary) focus elongation. If the applied modulation signal 140 is described by a function M(t), then M(tₓ)=Mₓ and M(tₛₒₗₗ)=Mₛₒₗₗ.

The difference Mₓ-Mₛₒₗₗ (or alternatively tₓ-tₛₒₗₗ) indicates how strong the detuning is, i.e. how strong ABS_{bisher} deviates from a target value ABS_{ziel} that is necessary for focusing for the distance control signal at the current measurement location on the sample surface. This difference therefore gives an indication of what kind of change ΔABS should be applied next for the distance control signal to quickly achieve focus. The dependence between the difference Mₓ-Mₛₒₗₗ (or tₓ-tₛₒₗₗ) and the change ΔABS of the distance control signal ABS to be made is strictly monotonic, and should be assumed to be linear (linear control function) in this variant.

Then the change ΔABS to be made can be determined as follows:

$$Δ ABS = ( {M}_{K} - {M}_{soll} ) * K 1 ,$$

where the constant K1 is a system constant inherent in the confocal microscope and usually does not fluctuate noticeably. Alternatively, ΔABS can be determined via ΔABS=(tₓ-tₛₒₗₗ)*K2, where the constant K2 is a system constant inherent in the confocal microscope and usually not fluctuating noticeably.

The distance control signal is then adjusted as follows to a new value ABSₙₑᵤ, where

$${ABS}_{neu} = {ABS}_{b i s h e r} + ΔABS .$$

After ABSₙₑᵤ is reached, tₓ or Mₓ can again be determined as previously described. In the ideal case (with good linearity and correct K1 or K2) the new tₓ will now be identical to tₛₒₗₗ or the new Mₓ will now be identical to Mₛₒₗₗ, so that the next change to be made is ΔABS=0, i.e. focus is achieved directly. Any remaining deviations from tₓ to tₛₒₗₗ or Mₓ to Mₛₒₗₗ can be minimized iteratively.

In the actual sample measurement, a distinction can be made between two frequently used measurement modes:

A first measuring mode, called precision mode, is used for particularly precise measurement of the sample. In this case, as soon as tₓ and tₛₒₗₗ or Mₓ and Mₛₒₗₗ (sufficiently) match, i.e. focus has been achieved, the actual measurement of the sample can begin at the current location sought during the scanning. Ah next location on the sample can then be sought, and a focusing and measurement of the sample can be carried out in an analogous manner, and so on.

Note that for an iterative adjustment of the distance control signal to the value ABS_{ziel} it is already sufficient to determine from the difference Mₓ-Mₛₒₗₗ (or tₓ-tₛₒₗₗ) an ΔABS having the correct sign (corresponding to a “directional knowledge”, see above) and its selected value must not be too large, so that the iterative adjustment converges toward achieving focus.

A second measurement mode, called quasi-continuous mode, is used for particularly fast measurement of the sample. The sample is continuously moved with the movement device to scan a specified region of the surface and to carry out a discrete number of sample light measurements. During this continuous movement, sample light is continuously measured. Due to the continuous movement, the sample light measured between neighboring grid points contains spatially averaged information about the sample properties. In this quasi-continuous measuring mode, the defocusing of the sample is continuously corrected according to the invention. For this purpose, a closed control loop, for example a PID controller, is used in the electronic control device and continuously generates a distance control signal in response to the momentary detuning, thus allowing the movement device to make constant corrections in order to achieve the most precise focus of the sample at any given time.

In summary, the invention describes a confocal microscope (1) comprising
an excitation light source (5) for an excitation light beam (6),
an excitation light beam splitter (7),
a point detector (14) with detector lens (13) for sample light (10) returning from a sample (2),
a microscope objective (4),
a movement device (3) for adjusting a relative distance (AB) between the microscope objective (4) and the sample (2),
an analysis device (16) comprising an analysis beam splitter (8) for coupling out a portion (11a) of the sample light (10) returning from the sample (2), an analysis lens system (12) for focusing the coupled-out portion (11a) toward an analysis detector (17), the analysis detector (17) for detecting the coupled-out portion (11a), and a modulation device (22) with which the refractive power of the analysis lens system (12) and/or a relative distance (RA) between the analysis detector (17) and the analysis lens system (12) can be cyclically varied over time according to a modulation signal (140), wherein, with the aid of a detector signal (150) of the analysis detector (17) a focus time (tₓ) is determined at which the coupled-out portion (11a) is focused on the analysis detector (17) and with which a distance control signal for the movement device (3) is generated. The confocal microscope makes possible a simple and reliable automatic tracking of the distance between the sample and the microscope objective.

List of reference signs:

| | |
|---|---|
| 1 | Confocal microscope |
| 2 | Sample |
| 3 | Movable sample holder/movement device |
| 4 | Microscope objective |
| 4a | Exit pupil of the microscope objective |
| 5 | Excitation light source |
| 5a | Exit aperture of the excitation light source |
| 5b | Lens of the excitation light source |
| 6 | Excitation light beam |
| 7 | Excitation light beam splitter |
| 8 | Analysis beam splitter |
| 9 | Sample-side beam focus |
| 10 | Sample light |
| 11a | Coupled-out portion of the sample light |
| 11b | Non-coupled-out portion of the sample light |
| 11c | Remaining portion of the sample light |
| 11d | First portion of the sample light |
| 12 | Analysis lens system |
| 12a | Entrance pupil of the analysis lens system |
| 13 | Detector lens |
| 14 | Point detector |
| 14a | Point detector entrance aperture |
| 14b | Spectrograph |
| 15 | Point-detector-side beam focus |
| 16 | Analysis device |
| 17 | Analysis detector |
| 17a | Entrance aperture of the analysis detector |
| 18 | Relay lens system |
| 19 | Electrically tunable lens (ETL) |
| 20 | Non-tunable lens |
| 21 | Analysis-detector-side beam focus |
| 22 | Modulation device |
| 23 | Electronic control device |
| 30 | Beam deflection wedge |
| 41 | Last lens of the analysis lens system |
| 42 | Focus (when in focus) |
| 43 | Focus (too far away for sample) |
| 44 | Focus (too close for sample) |
| 45 | Focus (at medium refractive power) |
| 46 | Focus (with increased refractive power) |
| 47 | Focus (with reduced refractive power) |
| 48 | Wobble device |
| 50 | Focus (slight detuning, sample slightly too far away) |
| 51 | Focus (greater detuning, sample clearly too far away) |
| 90 | Relay lens system |
| 101 | Entrance plane |
| 102 | Output plane |
| 103 | Fourier plane |
| 140 | Modulation signal |
| 150 | Detector signal |
| AB | (Momentary) distance between sample/local sample surface |
| | and microscope objective |
| ABₛₒₗₗ | Target distance between sample/local sample surface and |
| | microscope objective |
| ABS | Distance control signal |
| ABS_{bisher} | Previous value of the distance control signal |
| ABSₙₑᵤ | New value of the distance control signal |
| ABS_{ziel} | Target value of the distance control signal |
| ΔABS | Change in the distance control signal |
| BFL_i | Back focal length of element group i |
| D | Strength/intensity of the detector signal |
| d(1, 2) | Distance between element groups 1 and 2 |
| E1.1 | (First) imaging optical element of the first element group |
| E1.2 | (Second) imaging optical element of the first element group |
| E2.1 | (First) imaging optical element of the second element group |
| FFL_i | Front focal length of element group i |
| G1 | First imaging element group |
| G2 | Second imaging element group |
| GN | Last imaging element group |
| i | Index of element groups |
| j | Index of elements in an element group |
| M | Value of the modulation signal |
| M(t) | Function of the modulation signal |
| Mₘₐₓ | Maximum value of the modulation signal |
| Mₘᵢₙ | Minimum value of the modulation signal |
| Mₛₒₗₗ | Target value of the modulation signal/target focus elongation |
| Mₓ | Value of the modulation signal at the maximum of the |
| | detector signal/at time tₓ/momentary focus elongation |
| N | Number of element groups |
| RA | Relative distance between analysis lens system and analysis |
| | detector |
| SC1 | Section of the beam path of the coupled-out portion |
| SC2 | Section of the beam path of the coupled-out portion |
| SW1 | Beam width (input side) |
| SW2 | Beam width (output side) |
| t | Time |
| tₛₒₗₗ | Target time of the maximum of the detector signal/target |
| | focus time |
| tₓ | Time at the maximum of the detector signal/momentary focus |
| | time |
| t₀ | Starting point of half the modulation cycle |
| t₁ | End time of half the modulation cycle |
| x | Direction |
| y | Direction |
| z | Direction |

1. A confocal microscope for imaging a sample, comprising:
an excitation light source that generates an excitation light beam;
an excitation light beam splitter that couples in the excitation light beam;
a point detector that registers a sample light caused by the excitation light beam and returning from the sample;
a microscope objective that focuses the excitation light beam onto the sample and collects the sample light returning from the sample;
a detector lens that images the sample light returning from the sample and collected by the microscope objective onto the point detector;
a movement device that adjusts a relative distance (AB) between the microscope objective and the sample according to a distance control signal (ABS); and
an analysis device comprising:
an analysis beam splitter that couples out a portion of the sample light returning from the sample;
an analysis lens system that focuses only the coupled-out portion of the sample light toward an analysis detector (17);
the analysis detector that detects the coupled-out portion of the sample light from the analysis lens system; and
a modulation device with which the refractive power of the analysis lens system and/or a relative distance (RA) between the analysis detector and the analysis lens system can be cyclically varied in time according to a modulation signal,
wherein the analysis device is configured to determine a focus time (tx) at which the coupled-out portion of the sample light is focused on the analysis detector in a particular modulation cycle of the modulation signal based on a detector signal of the analysis detector, and wherein the analysis device uses the focus time (tx) to generate the distance control signal (ABS) for the movement device in a relevant modulation cycle.

2. The confocal microscope according to claim 1, wherein the analysis device is configured to use the focus time (tx) to indirectly generate the distance control signal (ABS) for the movement device in the relevant modulation cycle by an elongation (Mx) of the modulation signal at the focus time (tx) being read out, and by the distance control signal (ABS) for the movement device being generated by means of this elongation (Mx) of the modulation signal at the focus time (tx).

3. The confocal microscope according to claim 1, wherein the analysis lens system comprises an electrically tunable lens whose refractive power can be changed cyclically over time by means of the modulation signal.

4. The confocal microscope according to claim 3, wherein a frequency of the modulation signal corresponds to a natural frequency of the electrically tunable lens.

5. The confocal microscope according to claim 3, wherein the analysis lens system comprises the electrically tunable lens on an input side and further comprises a non-tunable, imaging optical element on an output side.

6. The confocal microscope according to claim 3, wherein the electrically tunable lens is aligned horizontally.

7. The confocal microscope according to claim 1, wherein the analysis detector is arranged on a wobble device with which the position of the analysis detector in a propagation direction (x) of the coupled-out portion of the sample light can be changed cyclically over time.

8. The confocal microscope according to claim 1, wherein a relay lens system is arranged between the analysis beam splitter and the analysis lens system, with which relay lens system an exit pupil of the microscope objective is imaged onto an entrance pupil of the analysis lens system with an imaging factor ABF.

9. The confocal microscope according to claim 8, wherein the relay lens system comprises an even number N of imaging element groups (Gi), wherein each imaging element group (Gi) comprises at least one imaging optical element (E1.1, E1.2, E2.1), wherein each imaging element group I (Gi) can be assigned a front focal length FFL_i, a back focal length BFL_i and an effective focal length EFL_i, with i: index of the imaging element groups (Gi), and
wherein the exit pupil of the microscope objective is positioned at least approximately at a distance FFL_1 in front of the first imaging element group i=1, (G1), and the entrance pupil of the analysis lens system is positioned at least approximately at a distance BFL_N behind the last imaging element group i=N (GN), and adjacent element groups I, i+1 (Gi, Gi+1) are positioned at least approximately at a distance d(I, i+1)=BFL_i+FFL_i+1 from one another.

10. The confocal microscope according to claim 9, wherein at least one imaging element group (Gi) comprises at least two imaging optical elements (E1.1, E1.2, E2.1).

11. The confocal microscope according to claim 9, wherein the first imaging element group (G1) comprises at least two imaging optical elements (E1.1, E1.2), and these imaging optical elements (E1.1, E1.2) are selected such that FFL_1>BFL_1.

12. The confocal microscope according to claim 8, wherein the imaging factor ABF=1.

13. The confocal microscope according to claim 8, wherein the imaging factor ABF is magnifying, with ABF>1.

14. The confocal microscope according to claim 1, wherein the analysis detector has an entrance aperture with a diameter which is not greater than a diameter of the coupled-out portion of the sample light that is completely focused by means of the analysis lens system, and wherein the analysis device is configured to determine the focus time (tx) by an intensity (D) of the detector signal in the modulation cycle at the focus time (tx) being at a maximum.

15. A method of imaging a sample with a confocal microscope according to claim 1, the method comprising:
measuring the sample successively at a plurality of measuring locations, wherein for a change of measuring location the sample is moved transversely to a propagation direction (z) of the excitation light beam, and wherein the distance control signal (ABS) generated by the analysis device is used to keep the relative distance (AB) between the microscope objective and a local surface of the sample at the relevant measuring location at least approximately constant across the various measuring locations with the movement device.

16. A method for imaging a sample
with a confocal microscope, the method comprising:
generating an excitation light beam with an excitation light source;
coupling in the excitation light beam with an excitation light beam splitter;
registering a sample light caused by the excitation laser beam and returning from the sample with a point detector;
using a microscope objective, focusing the excitation light beam onto the sample and collecting the sample light returning from the sample;
imaging, with a detector lens, the collected sample light returning from the sample onto the point detector; and
setting a relative distance (AB) between the microscope objective and the sample according to a distance control signal (ABS) generated by an analysis device comprising an analysis beam splitter which couples out a portion of the sample light returning from the sample, and an analysis lens system and analysis detector, wherein the analysis lens system focuses only the coupled-out portion of the sample light toward the analysis detector, and the analysis detector detects the coupled-out portion of the sample light,
wherein the analysis device comprises a modulation device with which the refractive power of the analysis lens system and/or a relative distance (RA) between the analysis detector and the analysis lens system is changed cyclically in time according to a modulation signal,
wherein the analysis device determines a focus time (tx) at which the coupled-out portion of the sample light is focused on the analysis detector in a particular modulation cycle of the modulation signal based on a detector signal of the analysis detector, and
wherein the analysis device uses the focus time (tx) to generate the distance control signal (ABS) for the movement device in a relevant modulation cycle.

17. The method according to claim 16, wherein the point detector is configured as a spectrograph and a spectral composition of the light returning from the sample is analyzed with the spectrograph, and
wherein fluorescence properties and/or Raman scattering properties of the sample are determined in the sample light returning from the sample.
